(19) United States
(12) Patent Application Publication
(10) Pub. No.: US 2008/0031673 A1
(43) Pub. Date: Feb. 7, 2008

(54) KEYBOARD STRUCTURE

(75) Inventors: Chao-Lung Chang, Jhunan Township (TW); Ching-Ting Lin, Jiaosi Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DARFON ELECTRONICS CORP., Taoyuan (TW)

(21) Appl. No.: 11/830,015

(22) Filed: Jul. 30, 2007

(30) Foreign Application Priority Data
Aug. 2, 2006 (TW) 95128394

(51) Int. Cl. B41J 5/12

(52) U.S. Cl. 400/490

(57) ABSTRACT

A keyboard structure includes a base, a circuit board, at least two keycaps and at least two linkages. The circuit board is disposed on the base. The two keycaps are adjacent to each other and disposed on the circuit board. Each keycap has a soft and a hard film. The soft film covers the hard film, the soft film has a pressing part penetrating the hard film, and the two soft films of the two keycaps are connected to each other. The two linkages are respectively disposed between the two keycaps and the base. Each of the linkages has two bars connected to each other, and each of the bars has one end connected to the base and the other connected to the hard film. The two keycaps can move up and down via the two linkages and press the two pressing parts to trigger the circuit board.

This application claims the benefit of Taiwan application Serial No. 95128394, filed Aug. 2, 2006, the subject matter of which is incorporated herein by reference.

### BACKGROUND OF THE INVENTION

1. Field of the Invention

The invention relates in general to a keyboard structure, and more particularly to a keyboard structure featured with functions of water and contamination proof, whose keycaps can move up and down stably.

2. Description of the Related Art

Keyboard is a basic component in a computer, which provides the user with an input interface for operating the computer or serves as one medium for communication between the user and the computer. Conventionally, the keyboard used in the computer consists of several keys. Gaps exist between the keys and each keycap is disposed open to the circuit board. After the keyboard is used for a long time, dust or contamination will be accumulated easily in the gaps between the keys, and as a result, it is not easy for the user to keep the keyboard clean. If the user splashes water on the keyboard incautiously, it will damage the circuit board of the keyboard and result in malfunction of the keys. Besides, normally, the computer-used keyboard will produce much noise in usage, which leads to unnecessary interference to the surrounding environment.

In a keyboard commonly used in a notebook computer, a rubber dome is designed between each keycap and the circuit board. When the user presses a keycap, the keycap will be pressed down to deform the rubber dome such that a carbon layer of the rubber dome is electrically coupled to the circuit board to output an operational signal of the corresponding key. However, because each keycap should operate with a rubber dome, too many components are used in the keyboard and the fabrication of the keyboard takes more labor and time relatively, which increases manufacturing cost of the keyboard. Besides, there exist gaps between the keys, the above problem of the keyboard with difficulty of cleanness maintenance and water proof is still not resolved.

Another keyboard used in a translation machine or a remoter is a keyboard made by a sheet of rubber. Although it has the features of water and contamination proof and producing less noise in the key pressing, it can not stabilize the up-and-down movement of the keys.

### SUMMARY OF THE INVENTION

The invention is directed to a keyboard structure whose keycaps and the circuit board form a close space to achieve the effects of water and contamination proof. The keycaps are connected to the circuit board via linkages and hard films are designed on the keycaps to stabilize the operation of the keys. The keycaps are connected to each other via soft films to form a sheet of keycap structure. Therefore, the keyboard structure can be simplified and easily fabricated, and the noise produced as pressing keys can be reduced to provide the user with a different feeling while using the keyboard.

According to a first aspect of the present invention, a keyboard structure is provided. The keyboard structure comprises a base, a circuit board, at least two keycaps and at least two linkages. The circuit board is disposed on the base. The two keycaps are adjacent to each other and disposed on the circuit board. Each of the two keycaps has a soft film and a hard film. The soft film is covered on the hard film, the soft film has a pressing part penetrating the hard film, and the two soft films of the two keycaps are connected to each other. The two linkages are respectively disposed between the two keycaps and the base. Each of the linkages has two bars connected to each other, and each of the bars has one end connected to the base and the other end connected to the hard film. The two keycaps can move up and down via the two linkages and accordingly press the two pressing parts to trigger the circuit board.

According to a second aspect of the present invention, a keyboard structure is provided. The keyboard structure comprises a base, a circuit board, at least two keycaps and at least two linkages. The circuit board is disposed on the base. The two keycaps are adjacent to each other and disposed on the circuit board. Each of the two keycaps has a soft film and a hard film, the hard film is covered on the soft film, the hard film has two protruding parts penetrating the soft film, and the soft film has a pressing part. The two linkages are respectively disposed between the two keycaps and the base. Each of the linkages has two bars connected to each other, and each of the bars has one end connected to the base and the other end connected to the two protruding parts. The two keycaps can move up and down via the two linkages and accordingly press the two pressing parts to trigger the circuit board.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a keyboard structure according to a first embodiment of the invention.

FIG. 2A is a schematic diagram of a keyboard structure according to a second embodiment of the invention.

FIG. 2B is a schematic enlarged diagram of the triggering region I₂ of FIG. 2A.

FIG. 3 is a schematic diagram of a keyboard structure according to a third embodiment of the invention.

FIG. 4A is a schematic diagram of a keyboard structure according to a fourth embodiment of the invention.

FIG. 4B is a schematic enlarged diagram of the triggering region I₄ of FIG. 4A.

### DETAILED DESCRIPTION OF THE INVENTION

### Embodiment One

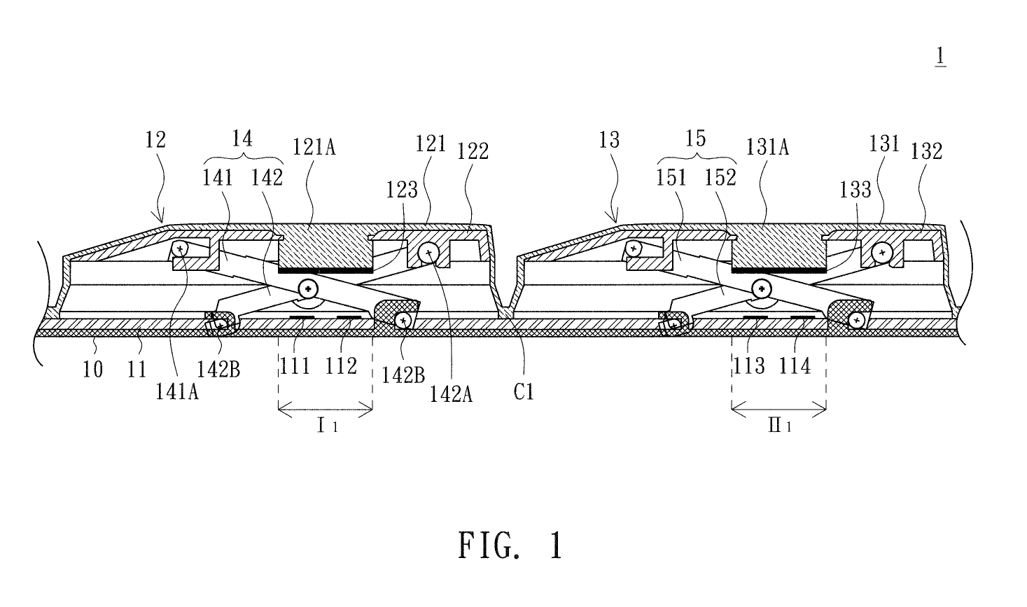

Referring to FIG. 1, a schematic diagram of a keyboard structure according to a first embodiment of the invention is shown. As shown in FIG. 1, a keyboard structure 1 includes a base 10, a circuit board 11, at least two keycaps 12, 13, and at least two linkages 14, 15. The circuit board 11 is disposed on the base 10, and the two keycaps 12 and 13 are adjacent to each other and disposed on the circuit board 11. The keycap 12 has a soft film 121 and a hard film 122. The soft film 121 covers the hard film 122. The soft film 121 has a pressing part 121A penetrating the hard film 122. The keycap 13 has also a soft film 131 and a hard film 132. The soft film 131 covers the hard film 132 and the soft film 131 has a pressing part 131A penetrating the hard film 132. The soft film 121 of the keycap 12 is connected to the soft film 131 of the keycap 13. The linkage 14 is disposed between the keycap 12 and the base 10 and includes two bars 141 and 142 connected to each other. The linkage 15 is disposed between the keycap 13 and the base 10 and has two bars 151 and 152 connected to each other. Each of the bars 141, 142, 151 and 152 has one end connected to the base 10. The other ends of the bars 141 and 142 are connected to the hard film 122 and the other ends of the bars 151 and 152 are connected to the hard film 132. The two keycaps 12 and 13 can move up and down via the two linkages 14 and 15 and accordingly the two pressing parts 121A and 131A can trigger the circuit board 11, respectively.

Preferably, the base 10 is a sheet of iron piece and the circuit board 11 is a thin film circuit board.

The circuit board 11 includes two triggering regions I₁ and II₁, disposed corresponding to the two pressing parts 121A and 131A. The keyboard structure 1 includes a first conductor 111 and a second conductor 112 in the triggering region I₁. The keyboard structure 1 also includes a first conductor 113 and a second conductor 114 in the triggering region II₁. When the user presses and moves the two keycaps 12 and 13 downward, the two pressing parts 121A and 131A are respectively moved close to the two triggering regions I₁ and II₁ such that the first conductors 111 and 113 are electrically coupled to the second conductors 112 and 114, respectively.

Preferably, as shown in FIG. 1, the pressing parts 121A and 131A of the two soft films 121 and 131 have respectively carbon layers 123 and 133. When the two pressing parts 121A and 131A move down to get close to the two triggering regions I₁ and II₁, the carbon layer 123 is electrically coupled to the first conductor 111 and the second conductor 112, and the carbon layer 133 is electrically coupled to the first conductor 113 and the second conductor 114. At the same time, the two triggering regions I₁ and II₁ of the circuit board 11 can respectively output key signals corresponding to the two keycaps 12 and 13 of the keyboard structure 1.

The linkages 14 and 15 have the same design, preferably. In the embodiment, only the linkage 14 is exemplified for illustration. The two bars 141 and 142 of the linkage 14 cross to each other in the keyboard structure 1. Preferably, the two bars 141 and 142 are connected via a pivot to form a scissors-shape structure. The bar 141 has a first end 141A and a second end 141B, and the bar 142 has a first end 142A and a second end 142B. The linkage 14 is connected to the keycap 12 via the first ends 141A and 142A and connected to the base 10 via the second ends 141B and 142B. For example, the first end 142A of the bar 142 is pivotally connected to the hard film 122 while the second end 142B is slidably connected to the base 10. The first end 141A and the second end 141B of the bar 141 are slidably connected to the base 10 and the hard film 122.

When the user presses the keycaps 12 and 13, the linkages 14 and 15 operating with the hard films 122 and 132 respectively can effectively improve the stability of the up-and-down movement of the keycaps 12 and 13.

As shown in FIG. 1, although the connection part C₁ of the soft films 121 and 131 is positioned on the circuit board 11, the connection part C₁ can also be unconnected to the circuit board 11. In the embodiment, an integral sheet of soft film is exemplified for illustration.

Besides, through technology of a dual-injection molding machine, the soft film 121 and hard film 122 of the keycap 12 are preferably manufactured into a unity, and the soft film 131 and hard film 132 of the keycap 13 are also preferably manufactured into a unity. At the same time, the soft film 121 is connected to the soft film 131 and the keycap 12 is connected to the keycap 13 to form a sheet of keycap structure. Because the soft film 121 is connected to the soft film 131 and located at the highest layer of the keyboard structure 1, this design can effectively isolate external objects such as dust and water from the keyboard structure 1.

In addition to effects of water and contamination proof, because the keycap and pressing part are manufactured into a unity, the keyboard structure 1 does not need the rubber domes as in the prior-art keyboard, which reduces the fabrication and production cost of the keyboard. The components of the keyboard structure 1 are covered by the soft film, which reduces the noise produced in the keyboard operation, and thus the keyboard structure 1 has the advantage of low noise production. Besides, the soft film also provides the users with a different touching feeling as they press the keycaps.

### Embodiment Two

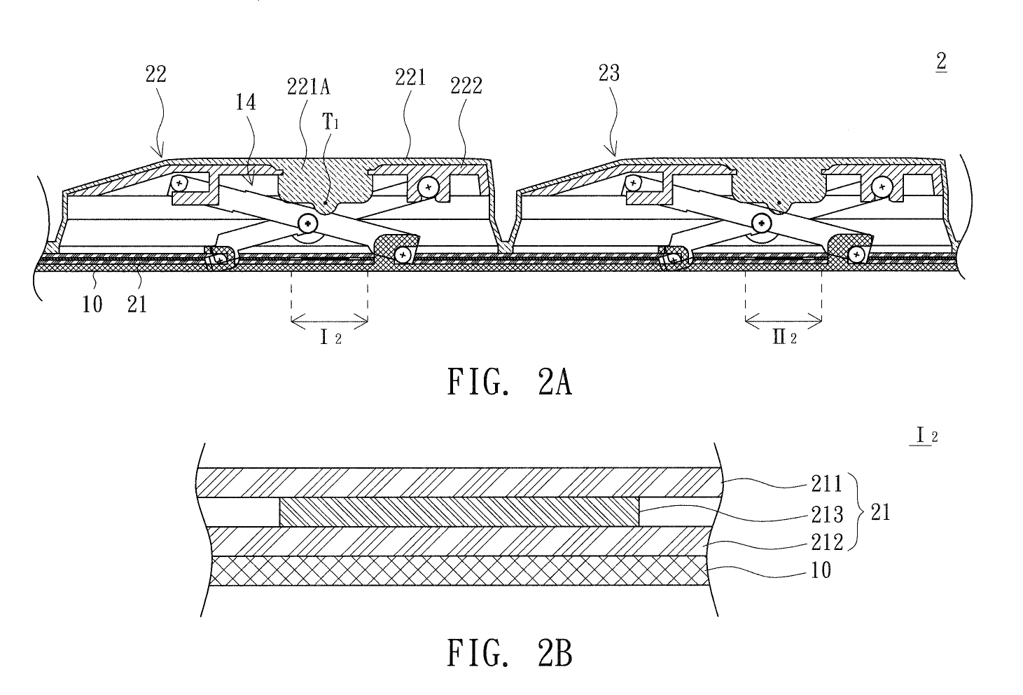

Referring to FIG. 2A, a schematic diagram of a keyboard structure according to a second embodiment of the invention is shown. The keyboard structure 2 of the second embodiment differs from the keyboard structure 1 of the first embodiment on the design of the triggering regions of the circuit board and the pressing parts of the keycaps. The other components still use the same symbols as in the first embodiment. Thus, any detail is not necessarily given here.

As shown in FIG. 2A, preferably, the keycaps 22 and 23 have the same design and the triggering regions I₂ and II₂ have the same design, and in the embodiment, only the keycap 22 and the triggering region I₂ are exemplified for illustration. The soft film 221 covers the hard film 222 of the keycap 22. The soft film 221 has a pressing part 221A that penetrates the hard film 222 and has a protruding point T₁.

Referring to FIG. 2B, a schematic enlarged diagram of the triggering region I₂ of FIG. 2A is shown. As shown in FIG. 2B, the circuit board 21 is disposed on the base 10 and has a first conductor 211, a second conductor 212 and an insulation layer 213 in the triggering region I₂. The first conductor 211 is disposed on the second conductor 212, and the insulation layer 213 is located between the first conductor 211 and the second conductor 212 such that the first conductor 211, the second conductor 212, and the insulation layer 213 form a triple-layer structure. When the user presses the keycap 22 to move the pressing part 221A close to the triggering region I₂, the protruding point T₁ contacts and presses the first conductor 211 such that the first conductor 211 moves close to the second conductor 212 to become electrically coupled to each other. At the moment, the triggering region I₂ of the circuit board 21 can output a key signal corresponding to the keycap 12 of the keyboard structure 2.

### Embodiment Three

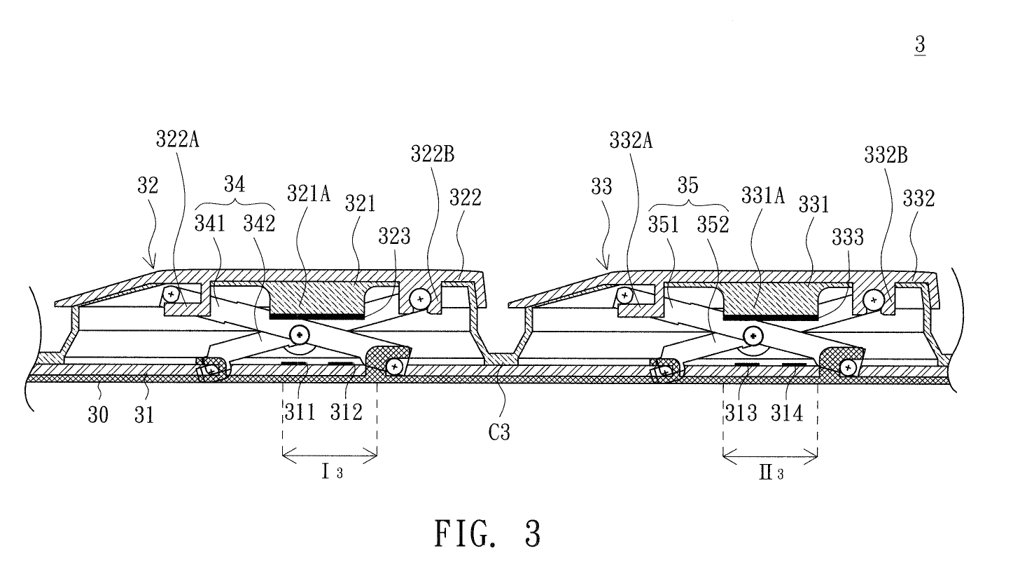

Referring to FIG. 3, a schematic diagram of a keyboard structure according to a third embodiment of the invention is shown. As shown in FIG. 3, a keyboard structure 3 includes a base 30, a circuit board 31, at least two keycaps 32 and 33 and at least two linkages 34 and 35. The circuit board 31 is disposed on the base 30, and the two keycaps 32 and 33 are adjacent to each other and disposed on the circuit board 31. The keycap 32 has a soft film 321 and a hard film 322, and the hard film 322 covers the soft film 321. The keycap 33 has a soft film 331 and a hard film 332 and the hard film 332 covers the soft film 331. The hard film 322 has two protruding parts 322A and 322B penetrating the soft film 321, and the hard film 332 has two protruding parts 332A and 332B penetrating the soft film 331. The two soft films 321 and 331 respectively have pressing parts 321A and 331A. The linkage 34 is disposed between the keycap 32 and the base 30, and has two bars 341 and 342 connected to each other. The linkage 35 is disposed between the keycap 33 and the base 30, and has two bars 351 and 352 connected to each other. Each of the bars 341, 342, 351 and 352 has one end connected to the base 30. The other ends of the bars 341, 342, 351 and 352 are respectively connected to protruding parts 322A, 322B, 332A and 332B. The two keycaps 32 and 33 can move up and down via the two linkages 34 and 35 and accordingly the two pressing parts 321A and 331A can trigger the circuit board 31, respectively.

As shown in FIG. 3, the circuit board 31 includes two triggering regions I₃ and II₃ disposed corresponding to the two pressing parts 321A and 331A. The keyboard structure 3 has a first conductor 311 and a second conductor 312 in the triggering region I₃. The keyboard structure 3 also has a first conductor 313 and a second conductor 314 in the triggering region II₃. The pressing part 321A of the soft film 321 has a carbon layer 323. The pressing part 331A of the soft film 331 has a carbon layer 333. When the user presses and moves the two keycaps 32 and 33 downward, the two pressing parts 321A and 331A are respectively moved close to the two triggering regions I₃ and II₃ such that the carbon layer 323 can electrically couple the first conductor 311 with the second conductor 312 and the carbon layer 333 can electrically couple the first conductor 313 with the second conductor 314. At the same time, the two triggering regions I₃ and II₃ of the circuit board 31 can respectively output the key signals corresponding to the two keycaps 32 and 33 of the keyboard structure 3.

In practical applications, the soft films 321 and 331 can be connected to or separated from each other. When the soft films 321 and 331 are separated from each other, the soft films 321 and 331 can be designed to connect with the circuit board 31. However, this design cannot avoid the possibility that water is splashed onto the circuit board 31. Therefore, preferably, the soft films 321 and 331 are connected to each other as shown in FIG. 3, and the connection part C₃ of the soft films 321 and 331 is positioned on the circuit board 31. This design can not only provide the keyboard structure 3 with waterproof function, but also increase stability of the structure between the keycaps 32 and 33.

### Embodiment Four

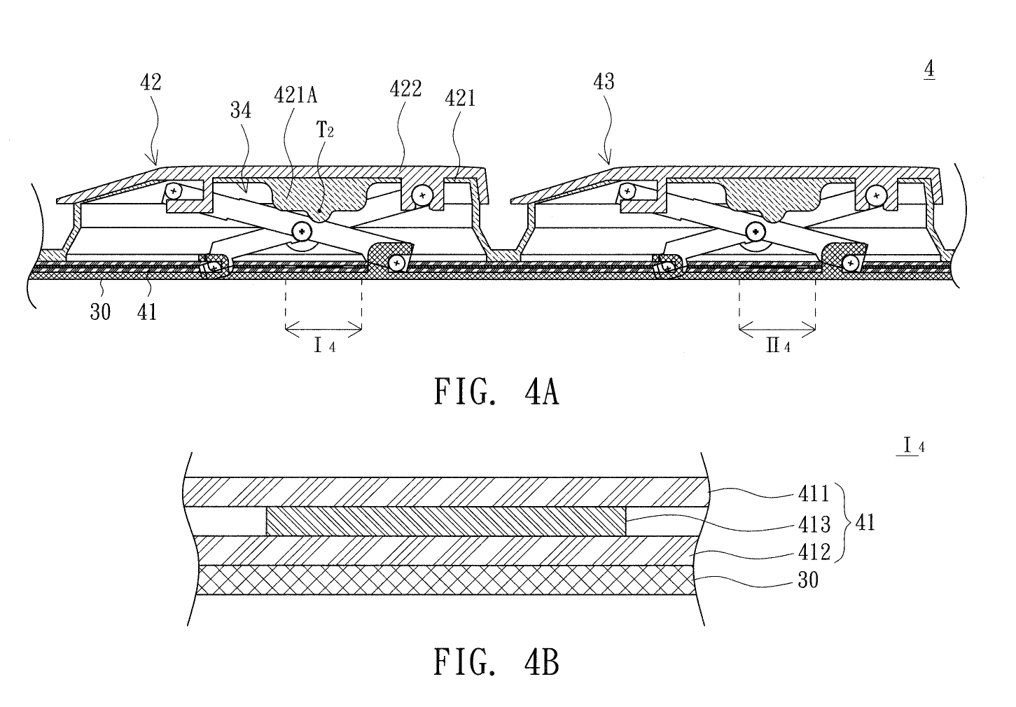

Referring to FIGS. 4A and 4B at the same time, a schematic diagram of a keyboard structure according to a fourth embodiment of the invention and a schematic enlarged diagram of the triggering region I4 of FIG. 4A are respectively shown. The keyboard structure 4 of the fourth embodiment differs from the keyboard structure 3 of the third embodiment on the design of the triggering regions of the circuit board and the pressing parts of the keycaps. The other components still use the same symbols as in the third embodiment. Thus, any detail is not necessarily given here. As shown in FIG. 4A, preferably, the keycaps 42 and 43 have the same design and the triggering regions I₄ and II₄ have the same design, and in the embodiment, only the keycap 42 and the triggering region I₄ are exemplified for illustration. The hard film 422 covers the soft film 421 of the keycap 42. The soft film 421 has a pressing part 421A. The pressing part 421A has a protruding point T₂.

As shown in FIG. 4B, the circuit board 41 is disposed on the base 30. The circuit board 41 has a first conductor 411, a second conductor 412 and an insulation layer 413 in the triggering region I₄. The first conductor 411 is disposed on the second conductor 412 and the insulation layer 413 is located between the first conductor 411 and the second conductor 412 such that the first conductor 411, the second conductor 412, and the insulation layer 413 form a triple-layer structure. When the user presses the keycap 42 to move the pressing part 421A close to the triggering region I₄, the protruding point T₂ contacts and presses the first conductor 411 such that the first conductor 411 moves close to the second conductor 412 to become electrically coupled to each other. At the moment, the triggering region I₄ of the circuit board 41 can output a key signal corresponding to the keycap 42 of the keyboard structure 4.

The keyboard structures 1˜4 of the above embodiments can be applied to a desktop computer, notebook computer, and portable electronic device.

In the keyboard structures disclosed by the above embodiments, the keycaps and the circuit board form a close space, which can effectively achieve the purpose of water and contamination proof. The keycaps are connected to the circuit board via linkages and hard films are designed on the keycaps, which can stabilize the key-pressing operation. The keycaps are connected to each other via soft films to form an integral keycap structure, which can reduce noise production. Besides, due to the simplified keyboard structure, fewer components are need to make the fabrication of the keyboard easier, which in turn reduces production cost and increases the keyboard's competitiveness in market.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A keyboard structure, comprising:
a base;
a circuit board, disposed on the base;
at least two keycaps, adjacent to each other and disposed on the circuit board, wherein each of the two keycaps has a soft film and a hard film, the soft film is covered on the hard film, the soft film has a pressing part penetrating the hard film, and the two soft films of the two keycaps are connected to each other; and
at least two linkages, respectively disposed between the two keycaps and the base, wherein each of the linkages has two bars connected to each other, each of the bars has one end connected to the base and the other end connected to the hard film, the two keycaps can move up and down via the two linkages and accordingly press the two pressing parts to trigger the circuit board.

2. The keyboard structure according to claim 1, wherein the circuit board has two triggering regions disposed corresponding to the two pressing parts, the keyboard structure further comprises a first conductor and a second conductor in each of the two triggering regions, when the two keycaps move down to bring the two pressing parts move close to the two triggering regions, the two first conductors are respectively electrically coupled to the two second conductors.

3. The keyboard structure according to claim 2, wherein each of the two pressing part has a carbon layer, when the two pressing parts move close to the two triggering regions, the two first conductors are electrically coupled to the two second conductors via the two carbon layers, respectively.

4. The keyboard structure according to claim 2, wherein each of the two triggering regions has an insulation layer disposed between the corresponding first conductor and second conductor, and the first conductor, the insulation layer, and the second conductor form a triple-layer structure;
when the two pressing parts move close to the two triggering regions and press the two first conductors such that the two first conductors get close to the two second conductors respectively, the two first conductors trigger the two second conductors, respectively.

5. The keyboard structure according to claim 1, wherein the connection part of the two soft films is positioned on the circuit board.

6. The keyboard structure according to claim 1, wherein the two bars cross to each other.

7. The keyboard structure according to claim 1, wherein the base is an iron piece.

8. The keyboard structure according to claim 1, wherein the circuit board is a thin film circuit board.

9. The keyboard structure according to claim 1, wherein the two soft films are respectively manufactured with the two hard films into a unity.

10. A keyboard structure, comprising:
a base;
a circuit board, disposed on the base;
at least two keycaps, adjacent to each other and disposed on the circuit board, wherein each of the two keycaps has a soft film and a hard film, the hard film is covered on the soft film, the hard film has two protruding parts penetrating the soft film, and the soft film has a pressing part; and
at least two linkages, respectively disposed between the two keycaps and the base, wherein each of the linkages has two bars connected to each other, each of the bars has one end connected to the base and the other end connected to the two protruding parts, the two keycaps can move up and down via the two linkages and accordingly press the two pressing parts to trigger the circuit board.

11. The keyboard structure according to claim 10, wherein the circuit board has two triggering regions disposed corresponding to the two pressing parts, the keyboard structure further comprises a first conductor and a second conductor in each of the two triggering regions, when the two keycaps move down to bring the two pressing parts to move close to the two triggering regions, the two first conductors are electrically coupled to the two second conductors, respectively.

12. The keyboard structure according to claim 11, wherein each of the two pressing part has a carbon layer, when the two pressing parts move close to the two triggering regions, the two first conductors are electrically coupled to the two second conductors via the two carbon layers, respectively.

13. The keyboard structure according to claim 11, wherein each of the two triggering regions has an insulation layer disposed between the corresponding first conductor and second conductor, and the first conductor, the insulation layer, and the second conductor form a triple-layer structure;
when the two pressing parts move close to the two triggering regions and press the two first conductors such that the two first conductors get close to the two second conductors respectively, the two first conductors trigger the two second conductors, respectively.

14. The keyboard structure according to claim 10, wherein the two soft films of the two keycaps are connected to each other.

15. The keyboard structure according to claim 10, wherein the two soft films of the two keycaps are separated from each other.

16. The keyboard structure according to claim 10, wherein the connection part of the two soft films is positioned on the circuit board.

17. The keyboard structure according to claim 10, wherein the two bars cross to each other.

18. The keyboard structure according to claim 10, wherein the base is an iron piece.

19. The keyboard structure according to claim 10, wherein the circuit board is a thin film circuit board.

20. The keyboard structure according to claim 10, wherein the two soft films are respectively manufactured with the two hard films into a unity.
